(19) United States
(12) Patent Application Publication
(10) Pub. No.: US 2010/0106859 A1
(43) Pub. Date: Apr. 29, 2010

(54) Method and system for synchronizing attributes among multiple electronic devices

(75) Inventors: Eun-Tae Won, Seoul (KR); Arun Naniyat, Byrasandra (IN); Giriraj Goya, Byrasandra (IN)

Correspondence Address: DOCKET CLERK, P.O. DRAWER 800889, DALLAS, TX, 75380, US

(73) Assignee: SAMSUNG ELECTRONICS CO. , LTD., Suwon-si (KR)

(21) Appl. No.: 12/589,624

(22) Filed: Oct. 26, 2009

(30) Foreign Application Priority Data
Oct. 26, 2008 (IN) 2600/CHE/2008

(51) Int. Cl. G06F 15/16

(52) U.S. Cl. 709/248

(57) ABSTRACT

A device is operable to perform a method for synchronizing attributes among multiple electronic devices is provided. The device is configured to scan a low energy Bluetooth® network for one or more attributes of a second electronic device. The device also is configured to establish a low energy Bluetooth® connection with the second electronic device. Further, the device is configured to synchronize the one or more attributes of the second electronic device and one or more attributes of the first electronic device. A system includes a first electronic device in electronic communication with a second electronic device over a low energy Bluetooth® network.

### CROSS-REFERENCE TO RELATED APPLICATION(S) AND CLAIM OF PRIORITY

The present application is related to and claims priority under 35 U.S.C. §119(e) to an application filed in the Indian Patent Office on Oct. 26, 2008 and assigned Serial No. 2600/CHE/2008, the contents of which are incorporated herein by reference.

### TECHNICAL FIELD OF THE INVENTION

The present disclosure relates generally to the field of wireless communication. More particularly, the present disclosure relates to a method and system for synchronizing attributes among multiple electronic devices using low power Bluetooth® technology.

### BACKGROUND OF THE INVENTION

In the existing environment, a user finds that time of different electronic devices has to be constantly synchronized with a correct time due to different conditions. Examples of the different conditions include, but are not limited to, a user travelling across different time zones, temperature conditions, and a weak battery. In one example, the user manually sets the time of a watch to the time displayed on a wall clock at a station. Such synchronization needs to be manually performed, which causes inconvenience and results in unnecessary delay.

In light of the foregoing discussion, there is a need for a method and system for synchronizing one or more attributes among multiple electronic devices using low power bluetooth technology.

### SUMMARY OF THE INVENTION

To address the above-discussed deficiencies of the prior art, it is a primary object to provide a method and system for synchronizing attributes among multiple electronic devices.

An example of a method for enabling synchronization of attributes among multiple electronic devices over a low energy Bluetooth® network includes scanning the low energy Bluetooth® network for one or more attributes of a second electronic device by a first electronic device. The method also includes establishing a low energy Bluetooth® connection between the first electronic device and the second electronic device. Further, the method also includes synchronizing the one or more attributes of the second electronic device and one or more attributes of the first electronic device.

An example of a system for enabling synchronization of attributes among multiple electronic devices over a low energy Bluetooth® network includes a first electronic device and a second electronic device. The first electronic device is in electronic communication with the second electronic device over the low energy Bluetooth® network. The first electronic device includes a processor operable to scan the low energy Bluetooth® network for one or more attributes of a second electronic device by a first electronic device. The processor also establishes a low energy Bluetooth® connection between the first electronic device and the second electronic device. Further, the processor synchronizes the one or more attributes of the second electronic device and one or more attributes of the first electronic device.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an environment, in accordance with which various embodiments can be implemented;

FIG. 2 illustrates a block diagram of an electronic device, in accordance with one embodiment;

FIG. 3 illustrates a flow diagram for time and date synchronization between a first electronic device and a second electronic device, in accordance with one embodiment; and

FIG. 4 illustrates a flowchart for a method for enabling synchronization of attributes among multiple electronic devices over a low energy Bluetooth® network, in accordance with one embodiment.

Persons skilled in the art will appreciate that elements in the figures are illustrated for simplicity and clarity and may have not been drawn to scale. For example, the dimensions of some of the elements in the figures may be exaggerated relative to other elements to help to improve understanding of various embodiments of the present disclosure.

### DETAILED DESCRIPTION OF THE INVENTION

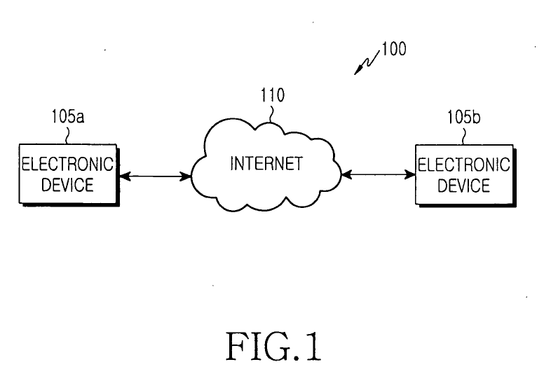

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system. It should be observed that method steps and system components have been represented by conventional symbols in the figures, showing only specific details that are relevant for an understanding of the present disclosure. Further, details that may be readily apparent to person ordinarily skilled in the art may not have been disclosed. In the present disclosure, relational terms such as first and second, and the like, may be used to distinguish one entity from another entity, without necessarily implying any actual relationship or order between such entities.

Embodiments of the present disclosure described herein provide a method and system for synchronizing attributes among multiple electronic devices.

FIG. 1 illustrates a block diagram of an environment 100, in accordance with which various embodiments can be implemented.

The environment 100 includes a plurality of electronic devices, for example an electronic device 105a and an electronic device 105b, connected through a network 110. In some embodiments, the network 110 is a low energy Bluetooth® network. Examples of the electronic devices include, but are not limited to, a computer, a laptop, a mobile device, a hand held device, a Personal Digital Assistant (PDA), a Bluetooth® enabled watch, and other Bluetooth® enabled devices.

The electronic devices include a first electronic device for initiating synchronization of one or more attributes with a second electronic device. Examples of the one or more attributes include, but are not limited to, time, day, date, month, year and calendar. The attributes for time further can be extended to seconds, divisions of a second. The synchronization is performed using attribute commands. The attribute commands include one of a read command and a write command. The electronic device 105a can act as the first electronic device and the electronic device 105b can act as the second electronic device. In some embodiments, the electronic device 105a can act as the second electronic device and the electronic device 105b can act as the first electronic device.

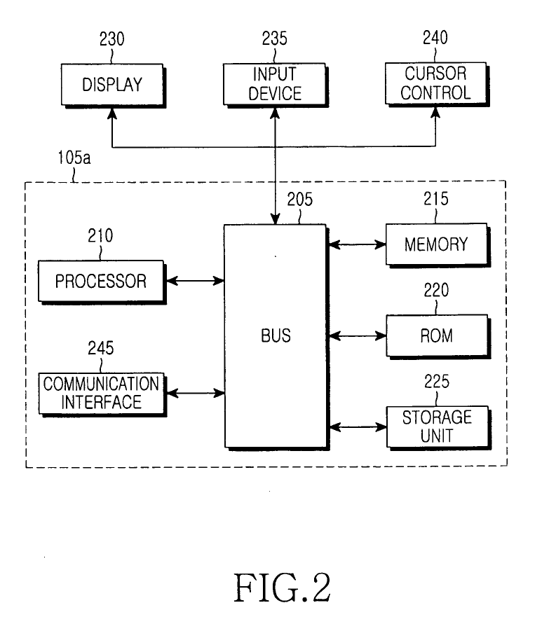

The electronic device 105a includes a plurality of components for enabling synchronization of the one or more attributes with the electronic device 105b. The electronic device 105a, including the components, is explained in detail in FIG. 2.

FIG. 2 illustrates a block diagram of the electronic device 105a, in accordance with one embodiment. The electronic device 105a includes a bus 205 for communicating information, and a processor 210 coupled to the bus 205 for processing the information. Examples of the information include attributes and attribute values. The electronic device 105a also includes a memory 215, for example, a random access memory (RAM) coupled to the bus 205 for storing information to be used by the processor 210. The memory 215 can be used for storing temporary information to be used by the processor 210. The electronic device 105a can further include a read only memory (ROM) 220 coupled to the bus 205 for storing static information to be used by the processor 210. A storage unit 225, for example a magnetic disk, hard disk or optical disk, can be provided and coupled to the bus 205 for storing the information.

The electronic device 105a can be coupled via the bus 205 to a display 230, for example, a cathode ray tube (CRT) or liquid crystal display (LCD), for displaying information. An input device 235, including various keys, is coupled to the bus 205 for communicating information to the processor 210. In some embodiments, cursor control 240, for example a mouse, a trackball, a joystick, or cursor direction keys, for communicating information to the processor 210 and for controlling cursor movement on the display 230 can also be present.

In one embodiment, the steps of the present disclosure are performed by the electronic device 105a using the processor 210. The information can be read into the memory 215 from a machine-readable medium, for example the storage unit 225. In alternative embodiments, hard-wired circuitry can be used in place of or in combination with software instructions to implement various embodiments.

The machine-readable medium can be a medium providing data to a machine to enable the machine to perform a specific function. The machine-readable medium can be a storage media. Storage media can include non-volatile media and volatile media. The storage unit 225 can be a non-volatile media. The memory 215 can be a volatile media. All such media are tangible to enable the instructions carried by the media to be detected by a physical mechanism that reads the instructions into the machine.

Examples of the machine readable medium include, but are not limited to, a floppy disk, a flexible disk, hard disk, magnetic tape, a CD-ROM, optical disk, punchcards, papertape, a RAM, a PROM, EPROM, and a FLASH-EPROM.

The electronic device 105a also includes a communication interface 245 coupled to the bus 205 for enabling data communication. Examples of the communication interface 245 include, but are not limited to, a Bluetooth® port.

In some embodiments, the processor 210 can include one or more processing units for performing one or more functions of the processor 210. The processing units are hardware circuitry performing specified functions.

The one or more functions include scanning the Bluetooth® network for one or more attributes of the second electronic device. The one or more functions also include establishing a low energy Bluetooth® connection between the first electronic device and the second electronic device. Further, the one or more functions include synchronizing the attributes of the second electronic device and one or more attributes of the first electronic device.

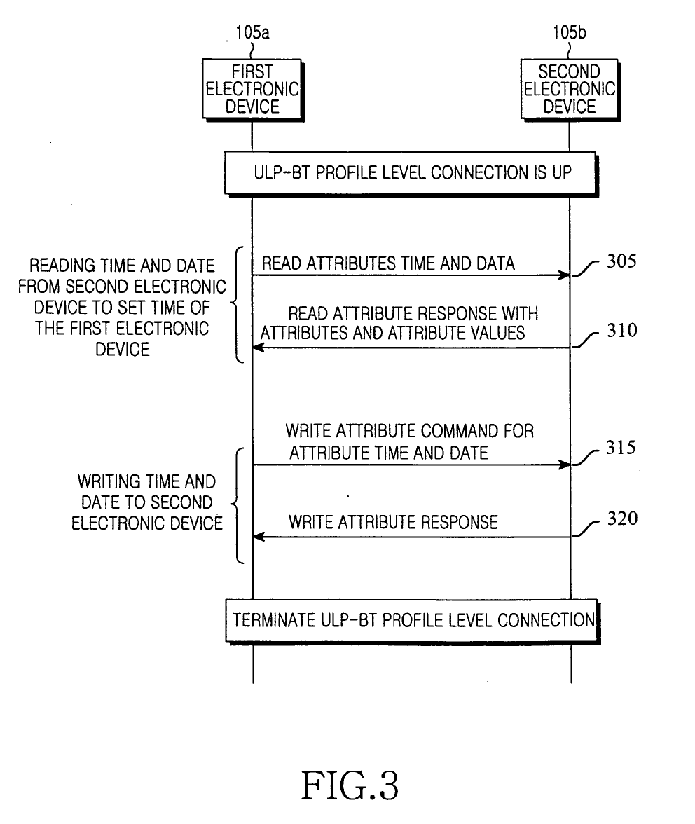

FIG. 3 illustrates a flow diagram for time and date synchronization between a first electronic device 105a and a second electronic device 105b, in accordance with one embodiment.

In the illustration, a synchronization profile, for example an ultra low power Bluetooth® profile connection, is established between the first electronic device 105a and the second electronic device 105b. The first electronic device 105a is an initiator device and the second electronic device 105b is a target device where time and date attribute values of the first electronic device is to be synchronized.

The first electronic device 105a sends a read attribute command 305 to the second electronic device 105b for reading one or more attributes, for example an attribute time and an attribute date. The second electronic device 105b then sends a read attribute response 310, with the attributes and the attribute values. For example, if the time and the date in the second electronic device 105b are 1:05:48 PM and 1 Oct., 2009 respectively, then the read attribute response 310 includes attribute time and an attribute value 130548, and the attribute date and the attribute value 011009.

In the illustration, the first electronic device 105a has a time corresponding to 1:10:52 PM and date 2 Oct. 2009, and the corresponding attributes value are 011052 and 021009 respectively. A write attribute command 315 is sent to the second electronic device 105b for writing the attribute time with the value 0110522 and 021009. In some embodiments, the writing of attributes can be specific to different applications.

Upon receiving the write attribute command, the second electronic device 105b acknowledges by sending a write attribute response 320. The time and date on the second electronic device 105b is changed to 1:10:52 PM and date 2 Oct., 2009.

In some embodiments, the second electronic device 105b can reject the write command 315.

Upon receiving the write attribute response, the first electronic device 105a can terminate the ultra low power Bluetooth® profile connection.

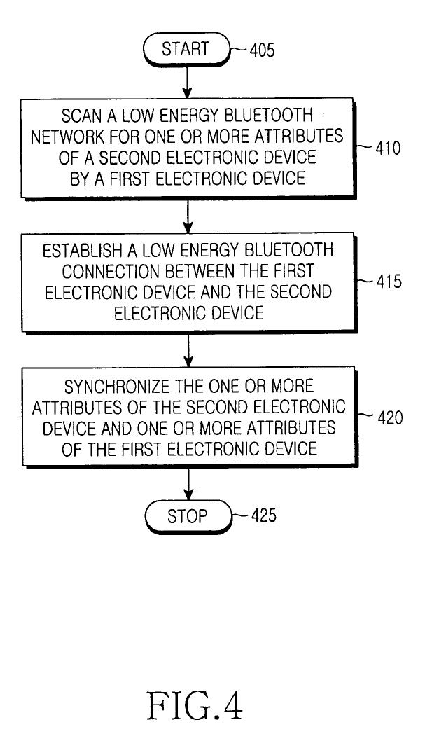

FIG. 4 illustrates a flowchart for a method for enabling synchronization of attributes among multiple electronic devices, for example a first electronic device and a second electronic device, over a low energy Bluetooth® network, in accordance with one embodiment.

The method starts at step 405.

At step 410, a low energy Bluetooth® network is scanned for one or more attributes of the second electronic device by the first electronic device. The attributes are advertised by the second electronic device. The attributes of the second electronic device are identified by the first electronic device. Examples of the attributes include, but are not limited to, time, day, date, month, year and calendar.

The electronic devices utilize one of an ultra low power Bluetooth®, a dual mode Bluetooth®, or a combination thereof.

At step 415, a low energy Bluetooth® connection is established between the first electronic device and the second electronic device. The first electronic device establishes the low energy Bluetooth® connection based on the identification of the one or more attributes, received from scanning of step 410. The connection can be associated with Bluetooth® profiles. The profiles define the attributes and protocols supported by each electronic device. A common supported protocol is then utilized by the electronic devices for further communication. For example, a synchronization profile can be defined for ultra low power Bluetooth®.

At step 420, the attributes of the second electronic device and one or more attributes of the first electronic device are synchronized.

In some embodiments, the synchronization is performed by writing one or more attribute values of the first electronic device to the second electronic device.

In some embodiments, the synchronization includes reading attributes of the second electronic device. The attributes are received in response to a read attribute command sent to the second electronic device by the first electronic device. The received attributes include the attributes listed in the read attribute command and an attribute value for each attribute in the second electronic device. A user associated with the first electronic device can then choose to synchronize the attributes of the second electronic device with the attributes of the first electronic device by sending a write attribute command to the second electronic device. The write attribute command includes the attributes values corresponding to the attributes of the first electronic device.

In some embodiments, the attribute commands are associated with a sixteen (16) bit Universal Unique Identifier (UUID), for example OX0046.

In other embodiments, one or more attributes values read from the second electronic device are written to the first electronic device.

In some embodiments, the synchronization also can include comparing the attributes of the first electronic device with the attributes of the second electronic device. If the attributes of the second electronic device differs from the corresponding attributes of the first electronic device, then the attributes of the first electronic device is applied to the second electronic device. If the attributes of the second electronic device is similar to the corresponding attributes of the first electronic device then the electronic devices are considered to be synchronized.

The method stops at step 425.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for enabling synchronization of attributes among multiple electronic devices over a low energy Bluetooth® network, the method comprising:
scanning the low energy Bluetooth® network for one or more attributes of a second electronic device by a first electronic device;
establishing a low energy Bluetooth® connection between the first electronic device and the second electronic device; and
synchronizing the one or more attributes of the second electronic device and one or more attributes of the first electronic device.

2. The method of claim 1, wherein synchronizing comprises one of:
reading the one or more attributes of the second electronic device; and
writing the one or more attributes of the first electronic device to the second electronic device.

3. The method of claim 2, wherein writing the one or more attributes comprises:
writing one or more attribute values to the second electronic device using one or more attribute commands.

4. The method of claim 1, wherein synchronizing further comprises:
reading the one or more attributes of the second electronic device; and
writing the one or more attributes of the second electronic device to the first electronic device.

5. The method of claim 4, wherein writing the one or more attributes comprises:
writing one or more attribute values to the first electronic device using one or more attribute commands.

6. The method of claim 1, wherein the one or more attributes comprise at least one of: a time, a date, a day, a year and a calendar.

7. The method of claim 1, wherein the electronic devices utilizes one at least one of: an ultra low power Bluetooth®, and a dual mode Bluetooth®.

8. The method of claim 7 further comprising:
defining a synchronization profile for the ultra low power Bluetooth®.

9. A system for enabling synchronization of attributes among multiple electronic devices over a low energy Bluetooth® network, the system comprising:
a first electronic device configured to communicate with a second electronic device over the low energy Bluetooth® network, the first electronic device comprising;
a processor operable to
scan the low energy Bluetooth® network for one or more attributes of a second electronic device by a first electronic device; and
establish a low energy Bluetooth® connection between the first electronic device and the second electronic device;
synchronize the one or more attributes of the second electronic device and one or more attributes of the first electronic device.

10. The system of claim 9, wherein the first electronic device further comprises:
a display;
an input device;
a cursor control; and
a memory.

11. The system of claim 9, wherein the processor is operable to one of:
read the one or more attributes of the second electronic device; and
write the one or more attributes of the first electronic device to a memory in the second electronic device.

12. The system of claim 11, wherein when writing the one or more attributes, the processor is operable to:
write one or more attribute values to the second electronic device using one or more attribute commands.

13. The system of claim 9, wherein when the processor synchronizes the one or more attributes, the processor is operable to:
read the one or more attributes of the second electronic device; and
write the one or more attributes of the second electronic device to a memory in the first electronic device.

14. The system of claim 13, wherein when the processor writes the one or more attributes, the processor is operable to:
write one or more attribute values to the first electronic device in response to one or more attribute commands.

15. The system of claim 9, wherein the one or more attributes comprise at least one of: a time, a date, a day, a year and a calendar.

16. The system of claim 9, wherein the first electronic device establishes the communication with the second electronic device utilizing one at least one of: an ultra low power Bluetooth®, and a dual mode Bluetooth®.

17. The system of claim 16, wherein the processor is operable to:
define a synchronization profile for the ultra low power Bluetooth®.

18. An electronic device, the electronic device comprising:
a communication interface configured to establish a communication with a second electronic device over a low energy Bluetooth® network; and
a processor configured to synchronize at least one attribute of the electronic device with a second electronic device.

19. The electronic device of claim 18, further comprising:
a display;
an input device;
a cursor control; and
a memory.

20. The electronic device of claim 18, wherein the processor is operable to one of:
read at least one attribute of the second electronic device; and
write at least one attribute of the first electronic device to a memory in the second electronic device.
